(19) United States
(12) Patent Application Publication
(10) Pub. No.: US 2011/0238210 A1
(43) Pub. Date: Sep. 29, 2011

(54) Vending Systems and Methods

(75) Inventor: Jurgen Roekens, Kampenhout (BE)

(73) Assignee: THE COCA-COLA COMPANY, Atlanta, GA (US)

(21) Appl. No.: 12/791,071

(22) Filed: Jun. 1, 2010

Related U.S. Application Data
(63) Continuation-in-part of application No. 12/731,168, filed on Mar. 25, 2010.

(51) Int. Cl. G06F 17/00; G07F 11/72; B65D 83/00; G06K 7/00

(52) U.S. Cl. 700/240; 221/2; 235/375

(57) ABSTRACT

The present application provides a vending system for dispensing a number of products. The vending system may include a number of enclosures with each of the enclosures including an access system, a weighing system positioned about the enclosures, and a user interface in communication with the access systems and the weighing system. The weighing system may be adapted to determine the number of products removed from the enclosures.

### RELATED APPLICATIONS

The present application is a continuation-in-part of U.S. Ser. No. 12/731,168, filed on Mar. 25, 2010, now pending. This application is incorporated herein by reference in full.

### TECHNICAL FIELD

The present application relates generally to vending systems and more particularly relates to a weight based vending system with tamper-proof access and an improved user interface.

### BACKGROUND OF THE INVENTION

Traditional vending machines generally are positioned in locations of moderate to heavy consumer traffic to ensure sufficient use and profitability. Locations with less consumer traffic, such as certain offices, hospitals, schools, retail establishments, and the like, may not be well suited for the usual size and expense related to the use of a traditional vending machine. Specifically, the components of the vending machine, such as the vending mechanism, the refrigeration equipment, the payment equipment, the product stocks, and the like, may be relatively expensive to provide and operate. Moreover, the size of the traditional vending machine may result in a slow rotation of product therethrough if the sales volume is relatively low. The noise and aesthetics associated with many vending machines also may not be appropriate for office use or use in other locations.

Coolers, particularly glass door coolers, may be somewhat less expensive to provide and operate given the lack of at least the vending mechanism. Glass door coolers also generally offer the advantage of allowing the consumer to see the products available within the cooler. Such visibility may provide the opportunity to promote the products therein and also may promote impulse purchases. The lack of the vending mechanism, however, generally means that the removal of the products from the cooler cannot always be controlled. Low cost payment solutions, such as an honesty box placed next to the cooler, may be provided but also may be subject to abuse given the lack of controlled access.

There is thus a desire for improved vending systems and methods. Such improved vending systems and methods may offer the positive features of a glass door cooler but with appropriate vending and payment controls. Such improved vending systems and methods also should be less expensive to provide and operate as compared to a traditional vending machine and the like.

### SUMMARY OF THE INVENTION

The present application thus provides a vending system for dispensing a number of products. The vending system may include a number of enclosures with each of the enclosures including an access system, a weighing system positioned about the enclosures, and a user interface in communication with the access systems and the weighing system. The weighing system may be adapted to determine the number of products removed from the enclosures.

The enclosures may include a number of glass door coolers. The enclosures may include a first enclosure with a first number of products of a first price and a second enclosure with a second number of products of a second price. The enclosures may include a first enclosure with a first number of products of a first temperature and a second enclosure with a second number of products of a second temperature. The enclosures may include a first enclosure with a first number of products of a first type and a second enclosure with a second number of products of a second type.

The enclosures each may include an access point and each access system may include a bar and/or a solenoid positioned about the access point. Each of the access systems may include a proximity sensor. The weighing system may include a number of weight transducers and a number of feet. The weighing system may include a frame sized to accommodate the number of enclosures.

The user interface may include a proximity card coupling device to read and write to a proximity card. The proximity card may include a key and the user interface may include a key hole for mating therewith. The user interface may include a display and a controller.

The present application further provides a method of vending a number of products of known weight from a number of enclosures to a consumer. The method may include the steps of receiving a value balance available to the consumer, providing access to one or more of the enclosures if the value balance meets or exceeds .a predetermined threshold balance, weighing the enclosures before and after a number of products have been removed, determining the number of products removed from the enclosures based upon the change in weight of the enclosures, determining the value of the products removed, and providing a revised value balance to the consumer.

The method further may include the step of determining which of the enclosures have been accessed while the step of determining the value of the products removed depends upon the enclosure accessed. The step of providing access to the enclosures may include releasing the door of a glass door cooler.

The present application further provides a vending system for vending a number of products. The vending system may include a number of glass door coolers with each of the glass door coolers including an access system, a common weighing system positioned about the glass door coolers, and a common user interface in communication with the access systems and the common weighing system. The glass door coolers may include a first glass door cooler with a first number of products of a first price and a second glass door cooler with a second number of products of a second price.

These and other features and improvements of the present application will become apparent to one of ordinary skill in the art upon review of the following detailed description when taken in conjunction with the several drawings and the appended claims.

### BRIEF DESCRIPTION OF THE DRAWINGS

FIG. 1 is a perspective view of a glass door cooler.

FIG. 2 is a front perspective view of a vending system as may be described herein.

FIG. 3 is a rear perspective view of the vending system of FIG. 2.

FIG. 4 is an exploded view of the vending system of FIG. 2.

FIG. 5 is an exploded view of a user interface of the vending system of FIG. 2.

FIG. 6 is an exploded view of the weighing system and the access system of the vending system of FIG. 2.

FIG. 7 is a flow chart showing the steps of a transaction with the vending system.

FIG. 8 is an exploded view of an alternative embodiment of a vending system as may be described herein.

FIG. 9 is an exploded view of the weighing system of the vending system of FIG. 8.

FIG. 10 is a perspective view of an alternative embodiment of a vending system as may be described herein.

FIG. 11 is an exploded view of the vending system of FIG. 10.

### DETAILED DESCRIPTION

The present application concerns the vending of any number of products 10. Although the products 10 are shown, by way of example only, in the form of bottles, it is understood that the products 10 may include any type or size of item or package, including, but not limited to, bottles, cans, pouches, boxes, wrapped items, produce, and/or any type of rigid or flexible packaging. The products 10 may include beverages, food items, non-food items, consumer products, and/or any type of product 10 that may be vended. The scope of this application is in no way limited by the nature of the products 10 intended to be vended herein or otherwise. Similarly, although one use herein is for a chilled product 10, it will be understood that the products 10 herein may be offered at ambient temperatures, frozen temperatures, elevated temperatures, or at any temperature.

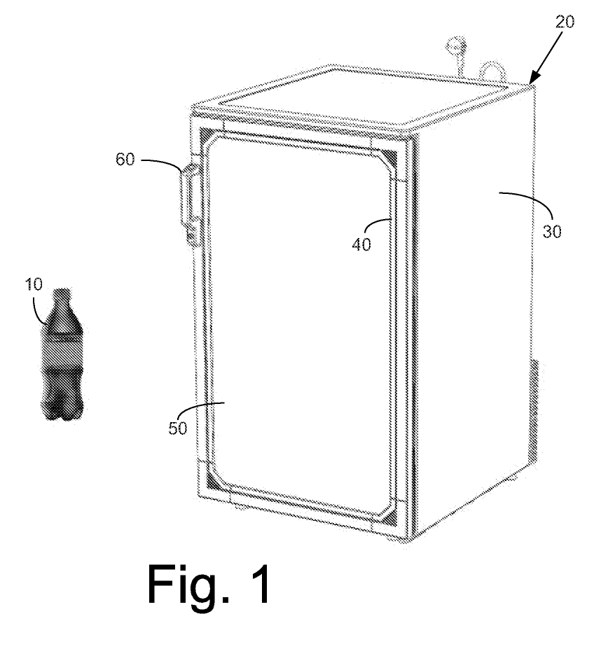

Referring now to the drawings, in which like numerals refer to like elements throughout the several views, FIG. 1 shows a cooler 20. As is known, the cooler 20 may include an outer frame 30 enclosed by a door 40. The frame 30 and the door 40 may be largely of conventional design and may be insulated as desired. The door 40 may include a transparent panel 50 therein. The transparent panel 50 may be made out of glass and the like. The door 40 may swing open and may include a handle 60. The cooler 20 may have any desired size or shape. The cooler 20 may include a cooling and/or heating device 70. The cooling and/or heating device 70 may be of conventional design. The cooler 20 may run on electrical power.

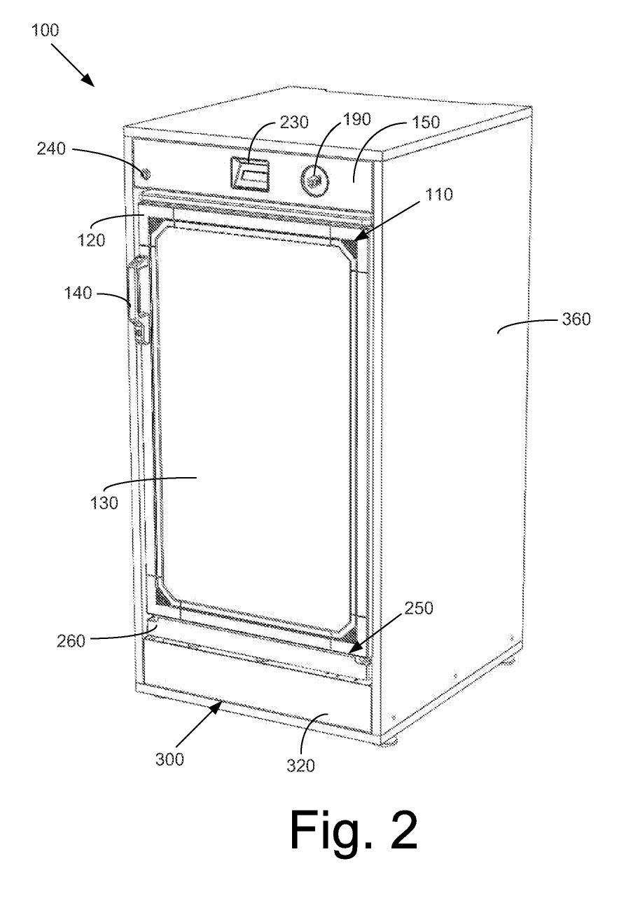

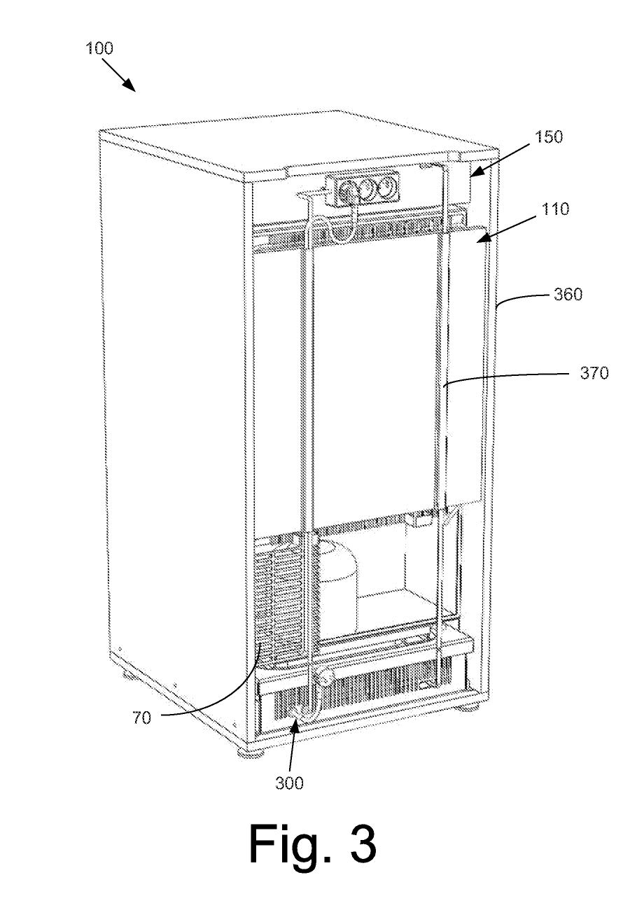

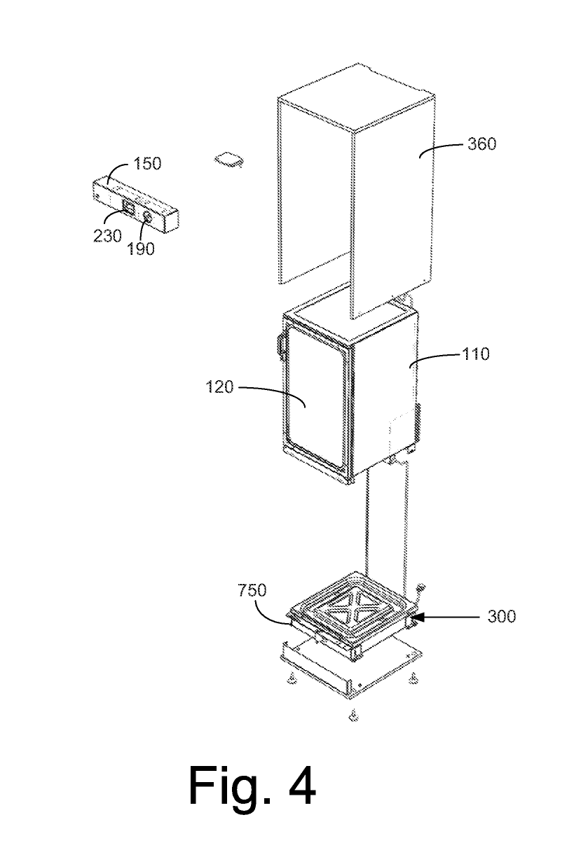

FIGS. 2-4 show a vending system 100 as may be described herein. The vending system 100 may include a cooler 110. The cooler 110 may be similar to the cooler 20 described above and may include a door 120 with a transparent panel 130 or other type of access point. The door 120 also may include a handle 140. The cooler 110 may have any desired size or shape and may be any type enclosure. No modification of the components of the cooler 110 may be required for use with the vending system 100. As such, the cooler 110 may be an existing unit or original equipment.

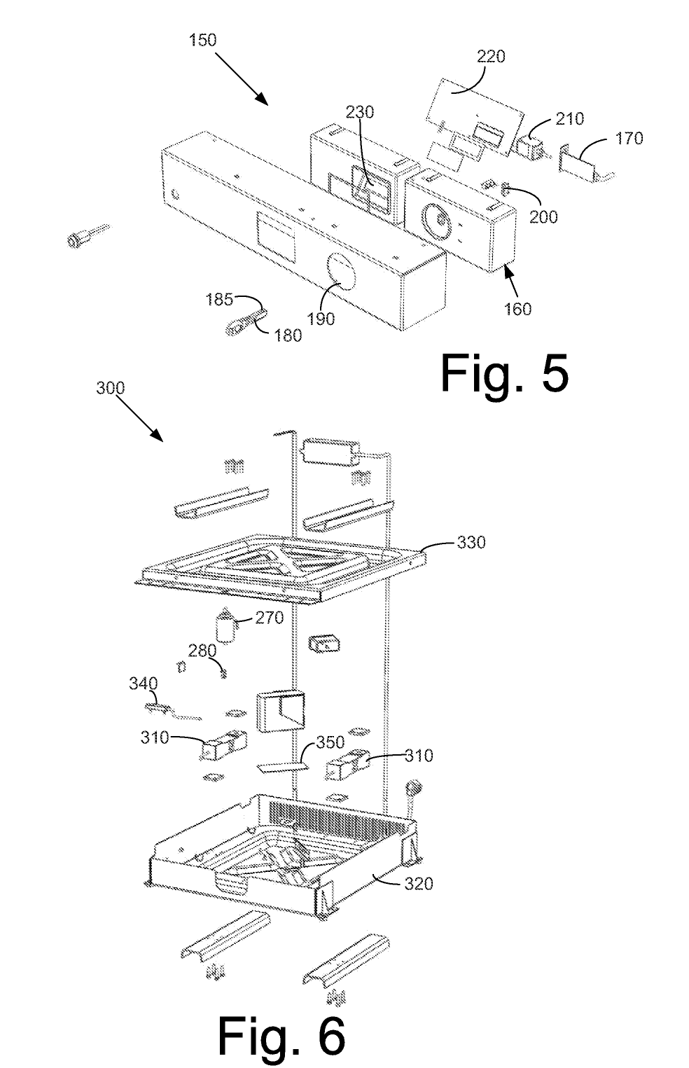

The vending system 100 also may include a user interface 150. The user interface 150 may be a separate module or integral with the system 100 as a whole. As is shown in FIG. 5, the user interface 150 may include an electronic payment system 160. In this example, the electronic payment system 160 may include a proximity card coupling device such as Radio Frequency Identification (“RFID”) reader 170 that may communicate with a proximity card such as a RFID card 180. The RFID card 180 may be a proximity card such as a MIFARE card offered by NXP Semiconductors of Eindhoven, Netherlands. Similar cards may be offered by Paytec Spa of Como, Italy. Similar devices may be used herein. The RFID card 180 may be positioned on a key 185 or other type of mounting.

In this example, the key 185 may be inserted within a key hole 190 of the user interface 150. One or more key sensing micro-switches 200 or similar devices may sense the presence of the RFID key 180 so as to activate the RFID reader 170. The RFID reader 170 then may read and/or write identification data, purchase data, or other types of information onto the RFID card 180 in a conventional manner. A key retaining solenoid 210 may be positioned about the RFID reader 170 so as to lock the key 185 within the key hole 190 during use or if misuse, abuse, or other types of undesirable conditions may be detected. (Non-contact systems also may be used such that the RFID card 180 simply may need to be in proximity to the RFID reader 170.) The RFID card 180 also may communicate with a reading and writing station (not shown) so as to add credit and/or other types of information to the RFID card 180. The reading and writing station also may be part of the user interface 150 or positioned elsewhere.

The user interface 150 may include a controller 220 therein. The controller 220 may be any type of conventional microprocessor and the like. The controller 220 may be in communication with the electronic payment system 160 and with the other components of the vending system 100 as a whole. A serial connector port and/or USB port or other types of communication means also may be used herein. Preferably, the electronic payment system 160 and the vending system 100 as a whole are not networked, but could be so if desired.

Although the electronic payment system 160 has been described herein in the context of the RFID reader 170, any other type of electronic payment device may be used such as other types of smart cards, cell phones, PDA's, and the like. Conventional cash and/or credit payment systems also may be used herein but may add to the expense and complexity of the vending system 100 as a whole.

The user interface 150 also may include a display panel 230. The display panel 230 may be a LED display, a video display, or any type of display device that may communicate with a user. The display panel 230 may have any desired size, shape, or position. Sound also may be used. The user interface 150 also may include a reset switch 240. The user interface 150 likewise may include other components and configurations herein.

The vending system 100 also may include an access system 250. As is shown in FIG. 6, the access system 250 may include a bar 260 or other structure positioned about the door 120 or other type of access point of the cooler 110. The bar 260 may be maneuverable via a solenoid 270. The solenoid 270 may maneuver the bar 260 so as to prevent or allow the door 120 of the cooler 110 to be opened. The bar 260 may be maneuvered in front of the door 120 or may otherwise engage the door 120 along the side or otherwise so as to prevent opening. The bar 260 may be in the form of a rail or a similar structure that prevents the door 120 from opening. Alternatively, the bar 260 may be static with an aperture or the like therethrough. The solenoid 270 thus may act as a locking pin positioned about the door 120. Likewise, other types of drive means may be used instead of the solenoid 270. The position of the bar 260 and/or the solenoid 270 may be determined by a status detector switch 280 or otherwise. The access system 250 may be in communication with the user interface 150 as will be described in more detail below. The access system 250 likewise may include other components and configurations.

The vending system 100 also may include a weighing system 300. The weighing system 300 may be a separate module or integral with the system 100 as a whole. The weighing system 300 may be positioned underneath the cooler 110. As is shown in FIG. 6, the weighing system 300 may include a number of weight transducers 310. The weight transducers 310 may be of conventional design and may sense changes in the weight of the cooler 110. Although two (2) weight transducers 310 are shown, any number may be used. The weight transducers 310 may be mounted on a base 320 and in communication with a lid 330. Other types of weight or load sensing mechanisms and devices may be used herein. The weighing system 300 may include a proximity sensor 340 to determine when the door 120 of the cooler 110 is closed. A controller 350 also may be used herein or the controller 220 of the user interface module 150 also may control the weighing system 300. The weighing system 300 may be in communication with the user interface 150. The weighing system 300 likewise may include other components and configurations.

The components of the vending system 100 may be positioned within a cabinet 360 or other type of enclosure. The use of the cabinet 360 may reduce the possibility of someone pushing down or up on the cooler 120 so as to vary the results of the weighing system 300 or otherwise tampering with the components of the vending system 100 as a whole. The cooler 110, the user interface 150, the access system 250, the weighing system 300, and other components herein may plug in or share a common electrical system 370. The electrical system 370 in turn may be communication with a conventional electrical outlet and the like.

Although the components of the access system 250 are shown as being integrated within the weighing system 300, the access system 250 and the weighing system 300 may be separate components. Moreover, numerous other configurations of elements may be used herein. For example, the user interface 150 may be positioned about the bottom of the cooler 110 if the vending system 100 is to be placed on, for example, a countertop. Further, one user interface 150 may be used with multiple coolers 110 as well as multiple weighing systems 300 and access systems 250. The coolers 110 may be side by side, stacked, or positioned in any other configuration. One cooler 110 may have more than one door 120 or access point.

In use, the cooler 110 may be stocked with a number of the products 10. The products 10 preferably, but not necessary, each have the same weight (at least within each compartment). Having multiple coolers 110 and/or multiple doors 120 may provide a vending system 100 with the ability to sell products 10 of different prices and/or different types of products 10. Multiple weighing systems 300 may be used for each type of product 10 or the controller 220 may attribute each weight differential to a specific type of product 10.

The weighing system 300 then determines the weight of the cooler 110. Based upon the weight, the controller 220 of the user interface 150 or otherwise, thus determines the number of products 10 currently positioned within the cooler 110. The display 230 of the user interface 150 may provide a message such as “Insert Your Key To Enjoy Your Drink And Hydrate Yourself” or any desired message. The required number of credits or cost also may be displayed. Any type of messaging may be used.

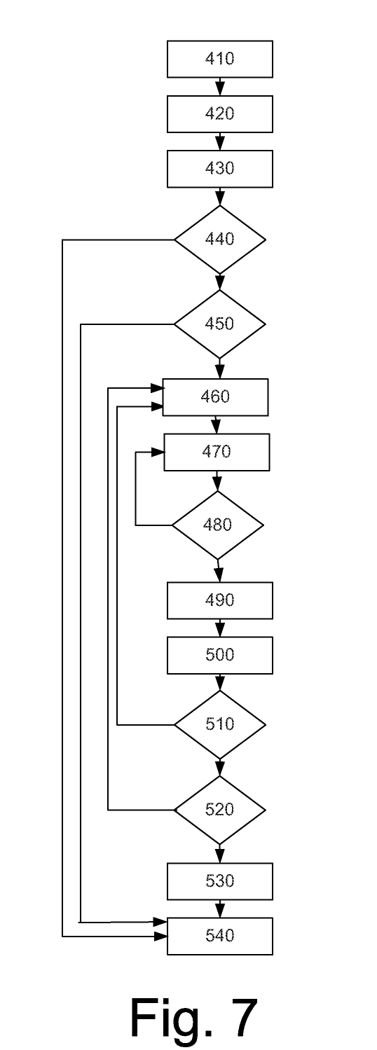

FIG. 7 is a flow chart showing the steps in one example of a vending transaction 400. The vending transaction 400 may begin at step 410 wherein the key 185 is inserted within the key hole 190 of the user interface 150. The key 185 may be locked into place via the key retaining solenoid at step 420 and then read by the RFID reader 170 at step 430. At step 440, the electronic payment system 160, in communication with the RFID reader 170 and the controller 220 or otherwise, may determine whether the RFID card 180 is authorized. At step 450, the electronic payment system 160 determines if the RFID card 180 has enough credit thereon. If the RFID card 180 is not authorized or if the RFID card 180 does not have sufficient credit, the key 185 may be released. The display 230 may instruct the user to charge the RFID card 180 with additional cash or credits.

If the RFID card 180 does have sufficient credit thereon, the door 120 may be unlocked via the access system 250 at step 460. The user then may remove one or more products 10 from the cooler 110 at step 470. At step 480, the proximity sensor 340 determines that the door 120 is closed and, if so, the access system 250 thus locks the door 120 at step 490.

At step 500, the weighing system 300 weighs the cooler 110. At step 510, the weighing system 300 determines if the weight is less than, equal to, or more than the previous weight. If the weight is more, the door 120 of the cooler 110 may be again unlocked as in step 460. The user likewise may be instructed to remove the additional weight such as an unauthorized product the user intended to chill. If the weight is less, the weighing system 300 determines whether the difference is a multiple of the product weight at step 520. If so, the monetary value or the credits for the number of products 10 removed is subtracted and a revised credit balance is written on the RFID card 180 via the RFID reader 170 at step 530. If the weight is equal, then no subtractions or revisions are made. The key 185 then may be released at step 540 and the transaction 400 is completed.

Although other protocols may be used herein, the RFID card 180 preferably has enough credit thereon to purchase at least one product 10 therein before the door 120 is opened. If more than the credit for one product 10 is required, a negative balance may be applied to the RFID card 180. The display 230 may remind the user to add credits or cash to the RFID card 180. Credit generally must be added and a positive balance must exist before the vending system 100 will vend another product 10.

Restocking the cooler 110 may be initiated by the use of a master RFID key 185. The master RFID key 185 may alert the vending system 100 that products 10 are to be added to the cooler 110. The electronic payment system 160 may write the number of products 10 inserted into the cooler 110 onto the master RFID key 180 or otherwise account for the additional products 10. Similarly, a self-service RFID key 185 also may be used. With a self-service key 185 and the like, users may stock the vending system 100 themselves as opposed to the traditional vending route supplier. Such a key 185 may be used only for a limited number of times so as to limit the chances of misuse and the like.

The vending system 100 thus may use an existing cooler 110 and provide controlled access thereto via the user interface 150 and the access system 250 while providing easy payment via the electronic payment system 160 and the weighing system 300. The vending system 100 thus is appropriate for use in either lower volume locations or locations where the aesthetics or noise of a traditional vending machine may not be appropriate. Specifically, the vending system 100 may be appropriate for small or medium sized enterprises where somewhat lower sales may be expected. The vending system 100 thus may have a relatively small size with associated lower noise levels so as to be appropriate in environments such as offices and the like.

Moreover, use of the vending system 100 or multiple systems 100 may greatly increase the number of vending opportunities even for larger enterprises. In other words, the density of vending opportunities and the number of points of interruption may be increased through the use of multiple vending systems 100. The closer a user is to the vending system 100, the greater chance of use.

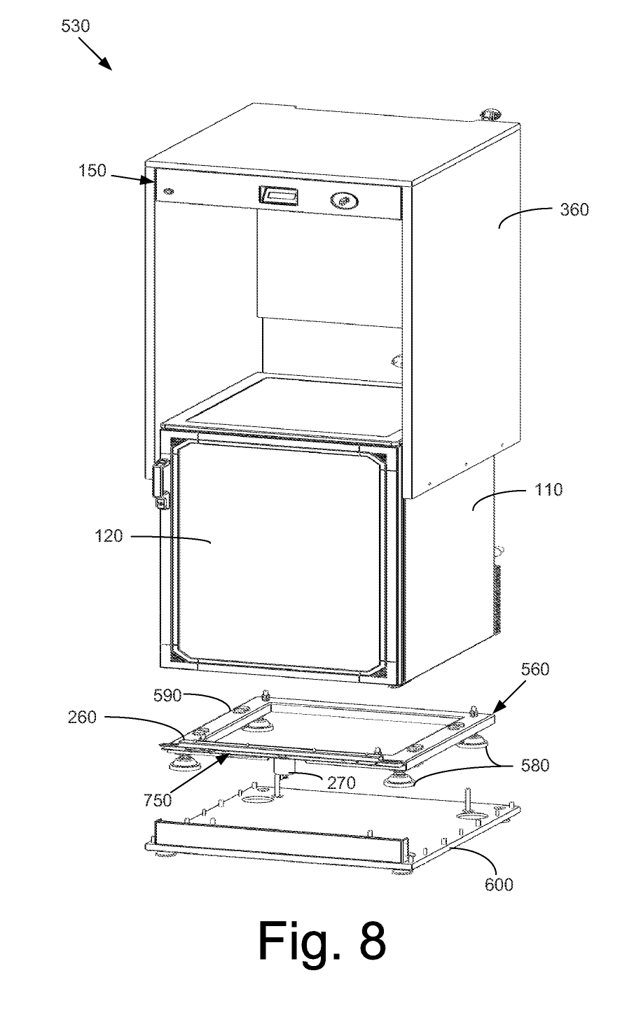

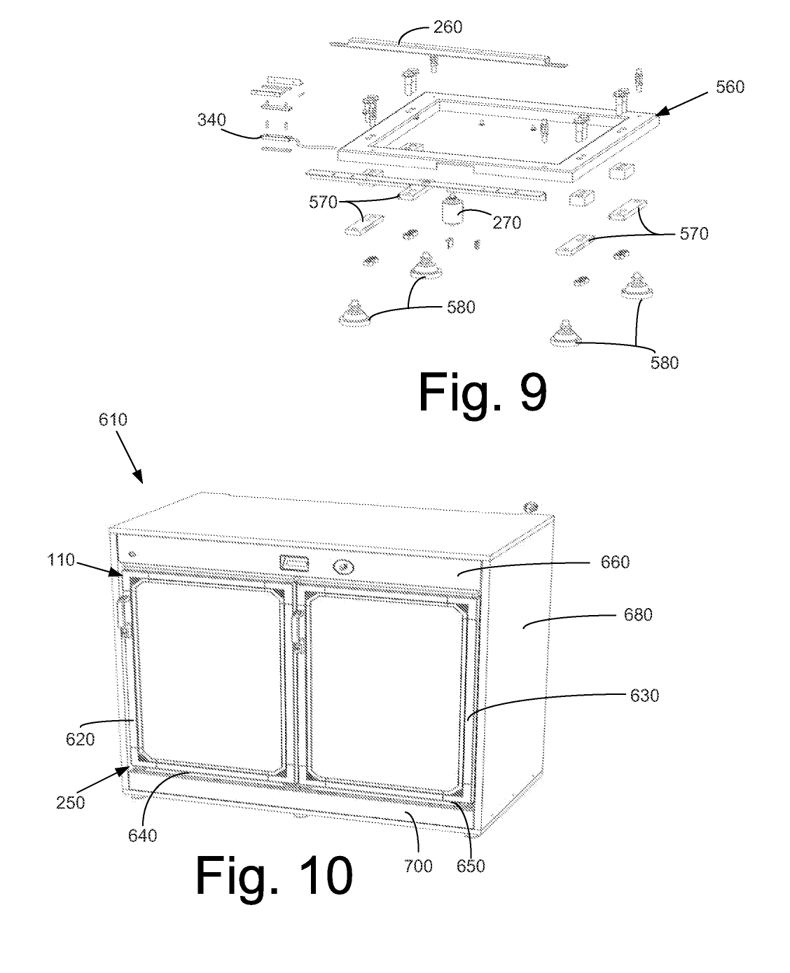

FIGS. 8 and 9 show an alternative embodiment of a vending system 550 as may be described herein. The vending system 550 may be similar to the vending system 100 described above. Specifically, the vending system 550 may use a similar cooler 110 with the door 120 and the transparent panel 130. Likewise, the vending system 550 may use a similar user interface 150 and a similar access system 250. Alternative systems also may be used herein. The overall components of the vending system 550 may be mounted within the cabinet 360 and the like.

The vending system 550 may use an alternative weighing system 560. Instead of a pair of weight transducers 210 positioned about the lid 330 in the weighing system 300 described above, the weighing system 560 in this example may use a number of weight transducers 570 positioned about a number of leveling feet 580. In this example, four (4) weight transducers 570 are positioned about four (4) leveling feet 580. Any number of weight transducers 570 and leveling feet 580 may be used herein. The weight transducers 570 and the leveling feet 580 may be mounted about a stiff frame 590. The cooler 110 may be mounted directly onto the stiff frame 590. The weighing system 560 may be positioned within a base 600 or other type of structure. Other configurations may be used herein. The weighing system 560 determines the weight of the cooler 110 and the products 10 therein and communicates this data in a manner similar to that described above.

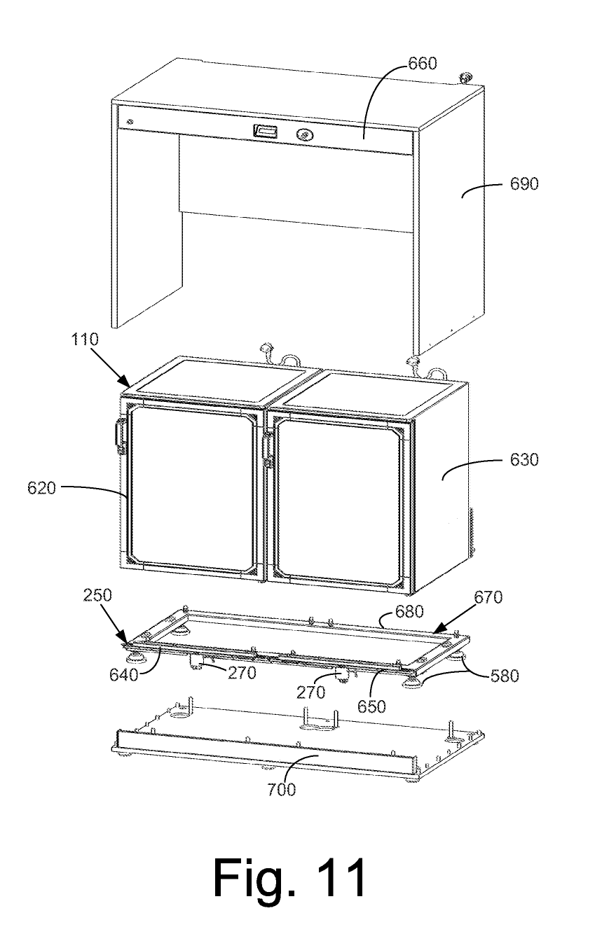

FIGS. 10 and 11 show a further alternative embodiment of a vending system 610 as may be described herein. The vending system 610 may be similar to the vending systems 100, 550 described above but includes the use of multiple coolers 110. In this example, a first cooler 620 and a second cooler 630 are shown. Any number of coolers 110, however, may be used herein.

Each of the coolers 120 may have an access system 250. The access systems 250 may be similar to that described above and may include the bar 260 and/or the solenoid 270 positioned about the door 120. In this example, a first access system 640 and a second access system 650 may be used with the first cooler 620 and the second cooler 630, respectively. As with the number of coolers 110, any number of the access systems 250 may be used herein. Alternatively, one (1) access system 250 may be used with multiple coolers 110. Each of the access systems 250 also may include its own proximity sensor 340 to determine when the door 120 of the related cooler 110 may be closed. One, several, or all of the access systems 250 may be activated during any given transaction so as to provide access to one, several, or all of the coolers 110. Alternative access system configurations also may be used herein.

The vending system 610 may include a common user interface 660. The common user interface 660 may be similar to the user interface 150 described above, but adapted for use with the multiple coolers 110 and the multiple access systems 250. The user interface 660 may be in communication with each of the access systems 250 and the weighing system as described below. Alternatively, multiple user interfaces 150 also may be used herein.

The vending system 610 also may include a common weighing system 670. The common weighing system 670 may be similar to the weighing system 300 or the weighing system 560 described above, but expanded for use with the multiple coolers 110. In this example, the common weighing system 670 may include the weight transducers 570 and the leveling feet 580 of the weighing system 560. The common weighing system 670 further may include an expanded frame 680. The expanded frame 680 may be sized to mate with the desired number of coolers 110. Any number of coolers 110 may be used with the common weighing system 670. Other configurations of the common weighing system 670 may be used herein. Multiple weighing systems 300, 560 also may be used herein.

The vending system 610 may include an expanded cabinet 690 and an expanded base 700. The cabinet 690 and the base 700 may be sized to accommodate the number of cooler 110 intended to be used. Any number of coolers 110 may be used herein. Other configurations of the cabinet 690 and the base 700 also may be used herein.

In use, the vending system 610 provides for the use of any number of coolers 110. Advantageously, the vending system 610 permits the use of the multiple coolers 110 with the common user interface 660 and the common weighing system 670. Only the access systems 250 have been duplicated in this example. The use of these common components thus should reduce the overall cost of providing and operating the vending system 610 as a whole.

The vending system 610 also may provide for price differentiation. For example, the first cooler 620 may have products 10 therein of a first price and the second cooler 630 may have products 10 therein of a second price. Although the common weighing system 670 may only determine the total weight differential in the vending system 610 as a whole, the controller 220 also may determine which door 120 of which cooler 620, 630 had been opened and thus may charge the user accordingly. Alternatively, multiple weighing systems 560 also may be used such that each cooler 110 includes its only weighing system 560 in communication with the controller 220. Other configurations may be used herein.

In addition to differently priced products 10, the vending system 610 also may accommodate products 10 at different temperatures. For example, the first cooler 620 may have products 10 therein of a first temperature and the second cooler 630 may have products 10 therein of a second temperature. As such the vending system 610 can accommodate heated products 10, cooled products 10, products 10 at ambient, frozen or partially frozen products 10, or products 10 at any temperature. Other types of product differentials may be provided herein. In other words, each cooler 110 may have a distinct product type therein.

The vending system 610 thus may provide not only a large number of products 10 therein but also a number of products with different prices, different temperatures, and other types of product differentials. Moreover, the vending system 610 provides the consumer with this product diversity while providing ease of use and security.

It should be apparent that the foregoing relates only to the preferred embodiments of the present application and that numerous changes and modifications may be made herein by one of ordinary skill in the art without departing from the general spirit and scope of the invention as defined by the following claims and the equivalents thereof.

We claim:

1. A vending system for vending a number of products, comprising:
a plurality of enclosures;
each of the plurality of enclosures comprising an access system;
a weighing system positioned about the plurality of enclosures;
the weighing system adapted to determine the number of products removed from the plurality of enclosures; and
a user interface in communication with the access systems and the weighing system.

2. The vending system of claim 1, wherein the plurality of enclosures comprises a plurality of glass door coolers.

3. The vending system of claim 1, wherein the plurality of enclosures comprises a first enclosure with a first number of products of a first price and a second enclosure with a second number of products of a second price.

4. The vending system of claim 1, wherein the plurality of enclosures comprises a first enclosure with a first number of products of a first temperature and a second enclosure with a second number of products of a second temperature.

5. The vending system of claim 1, wherein the plurality of enclosures comprises a first enclosure with a first number of products of a first type and a second enclosure with a second number of products of a second type.

6. The vending system of claim 1, wherein the plurality of enclosures each comprise an access point and wherein each access system comprises a bar positioned about the access point.

7. The vending system of claim 1, wherein the plurality of enclosures each comprise an access point and wherein each access system comprises a solenoid positioned about the access point.

8. The vending system of claim 1, wherein each access system comprises a proximity sensor.

9. The vending system of claim 1, wherein the weighing system comprises a plurality of weight transducers and a plurality of feet.

10. The vending system of claim 1, wherein the weighing system comprises a frame sized to accommodate the plurality of enclosures.

11. The vending system of claim 1, wherein the user interface comprises a proximity card coupling device to read and write to a proximity card.

12. The vending system of claim 11, wherein the proximity card comprises a key and wherein the user interface comprises a key hole for mating therewith.

13. The vending system of claim 1, wherein the user interface, comprises a display.

14. The vending system of claim 1, wherein the user interface comprises a controller.

15. A method of vending a number of products of known weights from a number of enclosures to a consumer, comprising:
receiving a value balance available to the consumer;
providing access to one or more of the number of enclosures if the value balance meets or exceeds a predetermined threshold balance;
weighing the number of enclosures before and after a number of the products have been removed;
determining the number of products removed from the number of enclosures based upon the change in weight of the number of enclosures;
determining the value of the number of products removed; and
providing a revised value balance to the consumer.

16. The method of claim 15, further comprising the step of determining which of the number of enclosures have been accessed.

17. The method of claim 16, wherein the step of determining the value of the number of products removed depends upon the enclosure accessed.

18. The method of claim 15, wherein the step of providing access to one or more of the number of enclosures comprises releasing the door of a glass door cooler.

19. A vending system for vending a number of products, comprising:
a plurality of glass door coolers;
the plurality of glass door coolers each comprising an access system;
a common weighing system positioned about the plurality of glass door coolers; and
a common user interface in communication with the access systems and the common weighing system.

20. The vending system of claim 19, wherein the plurality of glass door coolers comprises a first glass door cooler with a first number of products of a first price and a second glass door cooler with a second number of products of a second price.
